(19) United States
(12) Patent Application Publication
(10) Pub. No.: US 2026/0260446 A1
(43) Pub. Date: Sep. 3, 2026

(54) IDENTIFYING RELEVANT FEATURES BEHIND OBJECT DETECTION OUTCOME

(71) Applicant: INTERNATIONAL BUSINESS MACHINES CORPORATION, Armonk, NY (US)

(72) Inventors: Franck Vinh Le, West Palm Beach, FL (US); Supriyo Chakraborty, White Plains, NY (US)

(21) Appl. No.: 19/068,507

(22) Filed: Mar. 3, 2025

(51) Int. Cl. G06V 10/25; G06T 7/10; G06V 10/764

(52) U.S. Cl. CPC G06V 10/25; G06T 7/10; G06V 10/764; G06V 2201/07

(57) ABSTRACT

A method comprises reading an input image and an object identified by an object detection model. The method segments the input image into superpixels and generates a perturbed image of the input image. Each perturbation is associated with a superpixel. The object detection model identifies, for each of a set of superpixels, a predicted object. The method calculates a first relevance score for each superpixel based on an intersection over union of the bounding box of the predicted object and the bounding box of the identified object. The method generates, by a linear model, for each superpixel, a weight based on that superpixel and the relevance score of that superpixel. The method adds, to an output image, a superpixel associated with a highest weight. The method calculates a second relevance score for the output image. The method determines whether the second relevance score exceeds a relevance score threshold.

### BACKGROUND

Embodiments of the present disclosure relate to interpretation of machine learning models, and more specifically, to black-box methods of interpreting object detection models.

### BRIEF SUMMARY

In some embodiments, a computer-implemented method comprises reading an input image and an object identified by an object detection model. The identified object can be defined by a bounding box and a class. The method can include segmenting the input image into a plurality of superpixels. The method can include generating a plurality of perturbations of the input image to create a perturbed image. Each of the plurality of perturbations can be associated with one of the plurality of superpixels. The method can include identifying, for each of a set of superpixels of the plurality of superpixels of the perturbed image, at least one predicted object in that superpixel. The at least one predicted object can be defined by a bounding box and a class. The identifying can be performed using the object detection model. The method can include calculating a first relevance score for each superpixel of the set based on an intersection over union of the bounding box of the at least one predicted object of that superpixel and the bounding box of the identified object of the input image. The method can include generating, by a linear model, for each superpixel of the set, a weight based on that superpixel and the relevance score of that superpixel. The method can include adding, to an output image, a superpixel being associated with a highest weight of the plurality of weights generated by the linear model. The method can include calculating a second relevance score for the output image based on an intersection over union of the bounding box of a predicted object in the output image and the bounding box of the identified object of the input image. The method can include determining whether the second relevance score exceeds a relevance score threshold.

In some embodiments, the method can include responsive to determining that the output image's relevance score does not exceed the relevance score threshold, adding, to the output image, a second superpixel being associated with a second highest weight of the linear model.

In some embodiments, the method can include determining that the output image's relevance score exceeds the relevance score threshold and outputting the output image.

In some embodiments, the method can include determining that the output image's relevance score does not exceed the relevance score threshold and outputting the output image from a previous iteration.

In some embodiments, generating a plurality of perturbations comprises introducing an offset to each superpixel.

In some embodiments, the method can comprise masking each of the plurality of superpixels with a probability p.

In some embodiments, the method can include segmenting the output image into smaller superpixels, decreasing the probability p, and iterating any of the above methods by providing the segmented output image as the input image for a next iteration.

In some embodiments, calculating a relevance score for the first superpixel is further based on a prediction confidence.

In some embodiments, a system comprises a computing node comprising a computer readable storage medium having program instructions embodied therewith. The program instructions can be executable by a processor of the computing node to cause the processor to perform a method comprising reading an input image and an object identified by an object detection model, the identified object defined by a bounding box and a class. The method performed by the processor can further comprise segmenting the input image into a plurality of superpixels. The method performed by the processor can further comprise generating a plurality of perturbations of the input image to create a perturbed image, each of the plurality of perturbations being associated with one of the plurality of superpixels. The method performed by the processor can further comprise identifying, for each of a set of superpixels of the plurality of superpixels of the perturbed image, at least one predicted object in that superpixel. The at least one predicted object can be defined by a bounding box and a class. The identifying can be performed using the object detection model. The method performed by the processor can further comprise calculating a first relevance score for each superpixel of the set based on an intersection over union of the bounding box of the at least one predicted object of that superpixel and the bounding box of the identified object of the input image. The method performed by the processor can further comprise generating, by a linear model, for each superpixel of the set, a weight based on that superpixel and the relevance score of that superpixel. The method performed by the processor can further comprise adding, to an output image, a superpixel being associated with a highest weight of the plurality of weights generated by the linear model. The method performed by the processor can further comprise calculating a second relevance score for the output image based on an intersection over union of the bounding box of a predicted object in the output image and the bounding box of the identified object of the input image. The method performed by the processor can further comprise determining whether the second relevance score exceeds a relevance score threshold.

In some embodiments, the processor-executable program instructions, when executed by the processor, further cause the processor to, responsive to determining that the output image's relevance score does not exceed the relevance score threshold, add, to the output image, a second superpixel being associated with a second highest weight of the linear model.

In some embodiments, the processor-executable program instructions, when executed by the processor, further cause the processor to determine that the output image's relevance score exceeds the relevance score threshold and output the output image.

In some embodiments, the processor-executable program instructions, when executed by the processor, further cause the processor to determine that the output image's relevance score does not exceed the relevance score threshold, and output the output image from a previous iteration.

In some embodiments, generating the plurality of perturbations comprises introducing an offset to each superpixel.

In some embodiments, the method can comprise masking each of the plurality of superpixels with a probability p.

In some embodiments, the processor-executable program instructions, when executed by the processor, further cause the processor to segment the output image into smaller superpixels, decrease the probability p, and iterate any of the above methods performed by the processor by providing the segmented output image as the input image for a next iteration.

In some embodiments, calculating a relevance score for the first superpixel is further based on a prediction confidence.

In some embodiments, a computer program product for generating an explanation for a prediction of an object detection model. The computer program product can comprise a computer readable storage medium having program instructions embodied therewith. The program instructions can be executable by a processor to cause the processor to perform a method comprising reading an input image and an object identified by an object detection model. The identified object can be defined by a bounding box and a class. The method can comprise segmenting the input image into a plurality of superpixels. The method can comprise generating a plurality of perturbations of the input image to create a perturbed image. Each of the plurality of perturbations can be associated with one of the plurality of superpixels. The method can comprise identifying, for each of a set of superpixels of the plurality of superpixels of the perturbed image, at least one predicted object in that superpixel. The at least one predicted object can be defined by a bounding box and a class. The identifying can be performed using the object detection model. The method can comprise calculating a first relevance score for each superpixel of the set based on an intersection over union of the bounding box of the at least one predicted object of that superpixel and the bounding box of the identified object of the input image. The method can comprise generating, by a linear model, for each superpixel of the set, a weight based on that superpixel and the relevance score of that superpixel. The method can comprise adding, to an output image, a superpixel being associated with a highest weight of the plurality of weights generated by the linear model. The method can comprise calculating a second relevance score for the output image based on an intersection over union of the bounding box of a predicted object in the output image and the bounding box of the identified object of the input image. The method can comprise determining whether the second relevance score exceeds a relevance score threshold.

In some embodiments, the processor-executable program instructions, when executed by the processor, further cause the processor to, responsive to determining that the output image's relevance score does not exceed the relevance score threshold, add, to the output image, a second superpixel being associated with a second highest weight of the linear model.

In some embodiments, the processor-executable program instructions, when executed by the processor, further cause the processor to determine that the output image's relevance score exceeds the relevance score threshold and output the output image.

In some embodiments, the processor-executable program instructions, when executed by the processor, further cause the processor to determine that the output image's relevance score does not exceed the relevance score threshold and output the output image from a previous iteration.

In some embodiments, generating a plurality of perturbations comprises introducing an offset to each superpixel.

In some embodiments, the method can comprise masking each of the plurality of superpixels with a probability p.

In some embodiments, calculating a relevance score for the first superpixel is further based on a prediction confidence.

### BRIEF DESCRIPTION OF THE SEVERAL VIEWS OF THE DRAWINGS

FIG. 1 is a flowchart illustrating a method according to embodiments of the present disclosure.

FIG. 2 is a flowchart illustrating an iterative method according to embodiments of the present disclosure.

FIG. 3 is a schematic illustrating inputs and outputs to an object detection model and a linear model according to embodiments of the present disclosure.

FIG. 4 is a schematic illustrating an example of an output of an object detection model according to embodiments of the present disclosure.

FIG. 5 is an image illustrating an example of a prediction outcome of an object detection model for an image containing multiple instances of objects of a same class (e.g., train), where a user may want to explain one specific instance (e.g., the train in the smaller bounding box), according to embodiments of the present disclosure.

FIG. 6A is an image illustrating an example of segmentation to generate superpixels according to embodiments of the present disclosure.

FIG. 6B is an image illustrating an example of identification of relevant superpixels according to embodiments of the present disclosure.

FIG. 6C is an image illustrating an example of segmentation of relevant superpixels into smaller superpixels according to embodiments of the present disclosure.

FIG. 6D is an image illustrating an example of identification of relevant smaller superpixels according to embodiments of the present disclosure.

FIG. 6E is an image illustrating an example of image perturbation according to embodiments of the present disclosure.

FIG. 6F is an image illustrating an example of a generated explanation for an object detection model's detection of a train in an image according to embodiments of the present disclosure. Auto-Zoom highlights the train and also a portion of a rail.

FIG. 6F is an image 680 illustrating an example of a generated explanation for an object detection model's detection of a train in an image according to embodiments of the present disclosure. Auto-Zoom highlights the train and also a portion of a rail. As shown, the model relies on entities external to the bounding box of the object of interest (e.g., the rail that is used to detect the train of interest).

FIG. 7A is an image illustrating a toy example of perturbation with large superpixels.

FIG. 7B is an image illustrating a toy example of perturbation with small superpixels.

FIG. 8A is an image illustrating an example of an input image with three detected objects—bear, bench, and cat—according to embodiments of the present disclosure.

FIG. 8B is an image illustrating an example of an image with an adversarial patch according to embodiments of the present disclosure.

FIG. 8C is an image illustrating an example of a generated explanation for the detection of a dog object in an image according to embodiments of the present disclosure.

FIG. 9A is an image illustrating an example of a generated explanation for an object detection model's detection of a train in an image, where M, the number of superpixels, is set to 25, and p, the probability of masking superpixels, is set to 0.1, according to embodiments of the present disclosure.

FIG. 9B is an image illustrating an example of a generated explanation for an object detection model's detection of a train in an image, where M, the number of superpixels, is set to 100, and p, the probability of masking superpixels, is set to 0.1, according to embodiments of the present disclosure.

FIG. 10 is a schematic illustrating an example of a computing node according to embodiments of the present disclosure.

### DETAILED DESCRIPTION

In various embodiments of the present disclosure, a method and corresponding system, referred to throughout as Auto-Zoom, is a novel black-box explanation technique for an object detection outcome. Auto-Zoom can be provided a model, an image, and an identified object—defined by its bounding box, and class label. Auto-Zoom can identify the relevant features behind the model's prediction. In the present disclosure, it is first demonstrated that existing methods developed for image classifiers are not adequate for explaining object detection. Second, it is shown that recent work for explaining object detection can also fail to produce satisfactory explanations when a detected object is small, and depends on the surrounding context, external to the bounding box.

Towards this end, a novel hierarchical method and corresponding system called Auto-Zoom is introduced. This method segments an image into superpixels and iteratively identifies the most relevant ones through perturbations and a surrogate model before further segmenting the identified superpixels into smaller size superpixels. Finally, Auto-Zoom is compared with alternative blackbox explanation methods for object detection, and AutoZoom's effectiveness is demonstrated by localizing adversarial patches, which serve as ground truth explanation for a (mis)detection.

Deep learning based object detection models can localize and identify multiple objects in an image or video scene. Little effort has been devoted to understanding the outcome of detection models. Alternative methods of explanation techniques have primarily focused on image classifiers, which have their own limitations when it comes to explaining object detectors in black box settings. “Black-box” access can be access as one in which the user only has access to the input and output of the object detector model and no access to any of the model's internal parameters including gradients. For instance, alternative feature visualization based explanation techniques are unable to localize features relevant to a specific object, but typically do so for the entire scene. Alternative attribution-based explanation techniques are usually tightly coupled with the model architecture requiring gradient information, or customized relevance propagation rules, which are unavailable in black-box settings. Another alternative method, Detector Randomized Input Sampling for Explanation (D-RISE), has been proposed as an adoption of perturbation-based explanation for black-box explanations of object detectors. However, D-RISE fails to generate explanations for images with multiple small objects and contextual information.

In ano alternate method, LIME is a perturbation-based explanation approach that can associate relevance to superpixels in a black-box setting. Specifically, perturbations of the original image are created, predictions for the perturbations are obtained using the provided model, and an interpretable surrogate model (e.g., a regression model) is locally fit to identify the most relevant superpixels. In contrast to alternate methods such as LIME, in Applicant's disclosure, the relevance of a perturbed image (or superpixels) with regards to the object to be explained is assessed by taking into account both the prediction confidences of the identified objects in the perturbed image and the intersections of the bounding boxes of the identified objects in the perturbed image with the bounding box of the object to be explained. This ensures that the identified superpixels are relevant to the specific object to be explained, especially given that an image may contain multiple instances of objects of a class.

In various embodiment, the present disclosure provides a system and method that performs black-box explanation method for object detection. The system and method of the present disclosure is referred to in this document as Auto-Zoom throughout. Given a model, an input image, and an identified object—defined by its bounding box, and class—Auto-Zoom identifies the relevant features behind the model's prediction. Auto-Zoom further employs the concept of superpixels to infer meaningful features. Superpixels can extract meaningful features from images by grouping pixels of similar color and low-level properties.

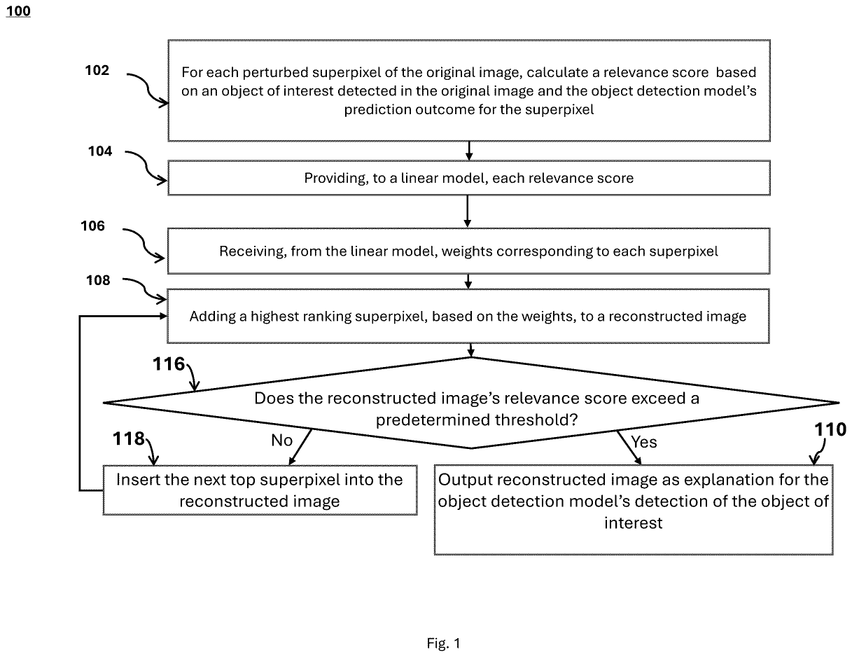

FIG. 1 is a flowchart 100 illustrating a method according to embodiments of the present disclosure. In some embodiments, a method calculates a relevance score for each perturbed superpixel of an original image (102). The relevance score can be based on an object of interest detected in the original image, or another detected object. The relevance score is calculated by an object detection model prediction outcome for that superpixel. The method can provide, to a linear model, each relevance score (104). In some embodiments, the relevance score can build or train a linear model. The method can receive, from the linear model, a weight corresponding to each superpixel (106). The method selects a highest ranking superpixel from those weights (e.g., the superpixel associated with the highest ranking weight) and adds that superpixel to a reconstructed image (108). The method then determines whether the reconstructed image's relevance score exceeds a threshold (116). If not, the method inserts the next highest ranked superpixel (118), and then determines whether the reconstructed image's relevance score exceeds a threshold again (116). If so, the method outputs the reconstructed image as an explanation for the object detection model's detection of the object of interest (110).

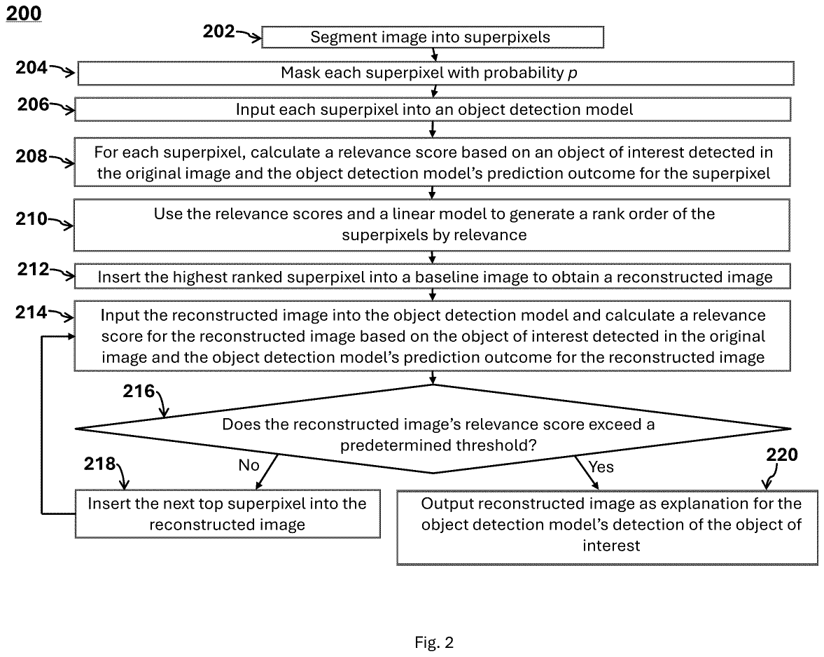

FIG. 2 is a flowchart 200 illustrating an method according to embodiments of the present disclosure. In some embodiments, the method is iterative. In various embodiments, at 202, an image is segmented into superpixels, and each superpixel is perturbed (e.g., via an introduced offset). In various embodiments, at 204, each superpixel is masked with a probability p. In various embodiments, at 206, each superpixel is inputted into an object detection model. In various embodiments, at 208, a relevance score is calculated for each superpixel based on the object of interest detected in the original image by the object detection model, and further based on the object detection model's prediction outcome for the superpixel. In various embodiments, at 210, the superpixel relevance scores and a linear model are used to generate a rank order of the superpixels by relevance. In various embodiments, at 212, the top (most relevant) superpixel is inserted into a baseline image (e.g., a black image) to obtain a reconstructed image. In various embodiments, at 214, the reconstructed image is inputted into the object detection model. A relevance score is calculated for the reconstructed image based on the object of interest detected in the original image by the object detection model, and further based on the object detection model's prediction outcome for the reconstructed image. In various embodiments, at 216, it is determined whether the reconstructed image's relevance score exceeds a predetermined threshold. In various embodiments, at 218, if the reconstructed image's relevance score does not exceed the predetermined threshold, the next top (next most relevant) superpixel is inserted into the reconstructed image and the workflow returns to 214. In various embodiments, at 220, if the reconstructed image's relevance score exceeds the predetermined threshold, the reconstructed image is outputted as an explanation for the object detection model's detection of the object of interest. Alternatively, to obtain a more fine-grained explanation, the relevant superpixel(s) in the reconstructed image are taken and segmented into smaller superpixels, the probability p of masking each superpixel is decremented, and the next iteration is performed by returning to 204. In some embodiments, a superpixel can have a method having similar steps applied to it for a more granular result (e.g., iterating the method on a superpixel level).

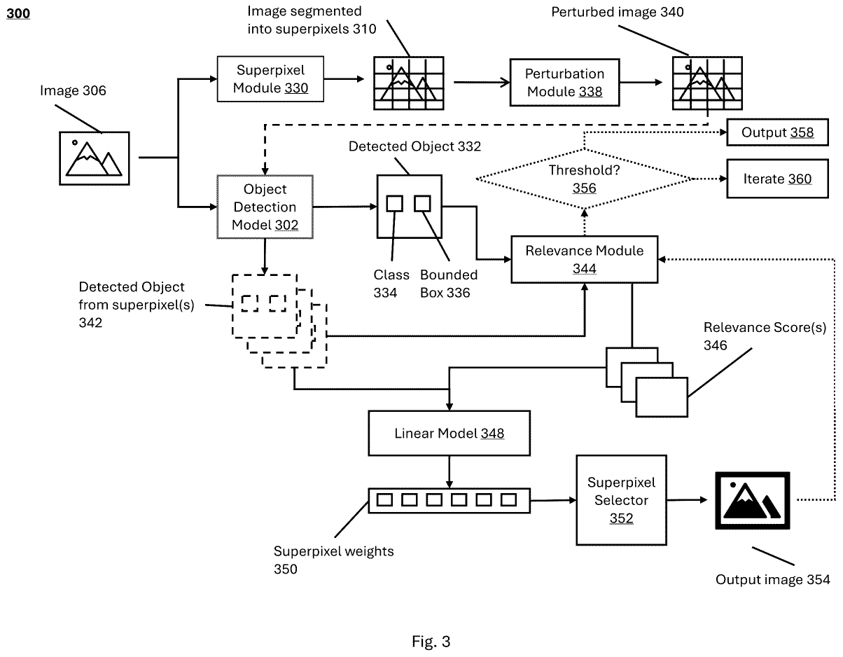

FIG. 3 is a block diagram 300 illustrating a system for generating a reconstructed image as an explanation of an object of interest according to embodiments of the present disclosure. In some embodiments, an image 306 is inputted into an object detection model 302. The object detection model 302 can output an detected object 332 (e.g., an identified object of interest). In parallel, the image 306 is provided to a superpixel module 330 that segments the image 306 into a plurality of superpixels 310. In some embodiments, a perturbation module 338 can generate a perturbed image 340 by introducing an offset to each pixel. In addition, each superpixel can be masked with a probability pᵢ. i can represent an index of each superpixel. The superpixels 310 with the probabilities p can be provided to the object detection model 302. The object detection model 302 provides object(s) identified in each superpixel and corresponding prediction confidence(s). It can be recognized that the detected objects 332 and 342 are provided in a same format with the same information (e.g., class 334 and bounded box 336), where detected objects 332 is applied to the image 306 as a whole and each detected object 342 is applied to a superpixel.

In various embodiments a relevance module 344 calculates relevance scores 346 for each superpixel 310. In various embodiments, the superpixel relevance scores 346 are provided into a linear model 348. The linear model 348 can generate a learned coefficient for each of the superpixels 310 and output them as superpixel weights 350. The superpixel weights 350 can be ranked by relevance, and the superpixels 310 can be ordered as such. A superpixel selector 352 can select the highest ranking weight and superpixel corresponding to that weight. In some embodiments, that superpixel is added to an output image 358.

The output image 354 can then be scored by the relevance module 344. If the score meets a threshold 356, then the output image 354 can be provided as an output explanation. Otherwise, the system can iterate 360 by selecting, with the superpixel selector 352, a next highest ranked superpixel weight 350 and corresponding superpixel. In the next iteration, the system can add that next selected superpixel to the output image 354.

In various embodiments, based on the reconstructed image's relevance score 346 the output image 354 can be outputted as an explanation for the object detection model's identification of the object of interest. In various embodiments, based on the reconstructed image's relevance score 346, the relevant superpixel(s) in the reconstructed image can be used as a starting point for a next iteration of the method, with the purpose of obtaining a more fine-grained explanation for the object detection model's identification of the object of interest. The relevant superpixel(s) in the reconstructed image can further be segmented into smaller superpixels, each of the smaller superpixels can be masked with a decremented probability p, and the smaller superpixels can be inputted into the object detection model 302.

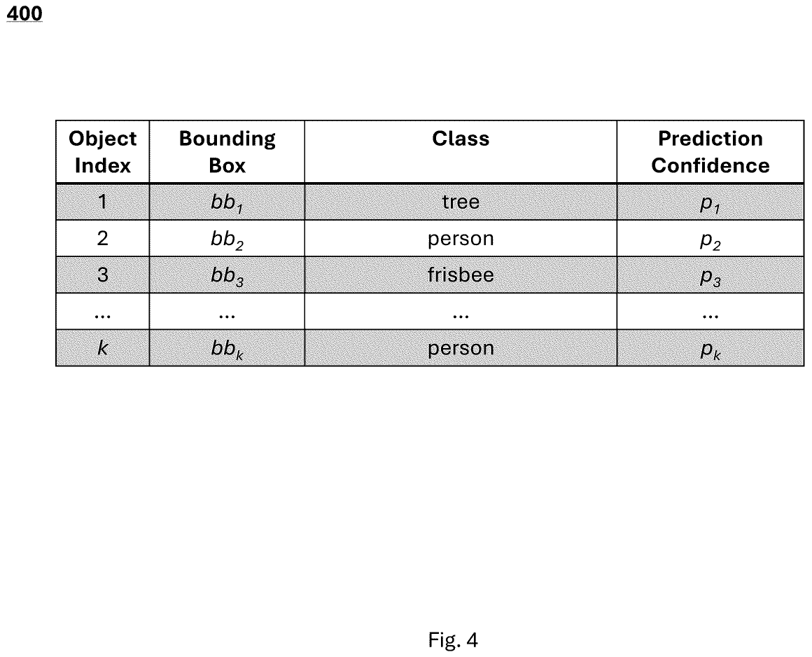

FIG. 4 is a table 400 illustrating an example of an output of an object detection model according to embodiments of the present disclosure. The output includes a plurality of objects detected by the object detection model, where each object has an object index i, a bounding box bbᵢ, a class, and a prediction confidence pᵢ. The bounding box defines the area of the image occupied by the detected object. The class defines the type of object detected, e.g., a tree, a person, or a frisbee.

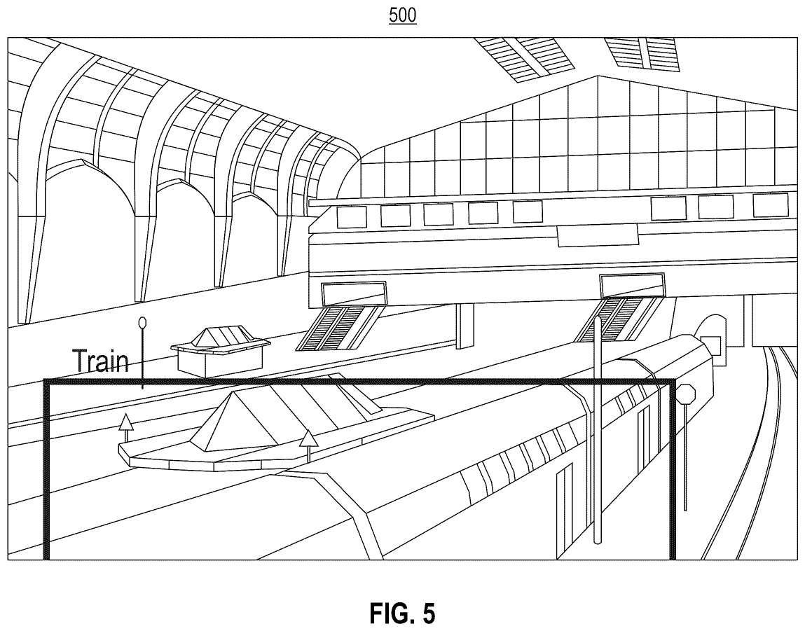

FIG. 5 is an image 500 illustrating an example of a prediction outcome of an object detection model for an image containing multiple instances of objects of a same class (e.g., train). A user can seek an explanation of a specific instance of object detection in the image (e.g., the train in the smaller bounding box), according to embodiments of the present disclosure. For this image, a user can desire to understand and identify the relevant features for the train on the left of the image (smaller bounding box), and not for the train in the front (larger bounding box).

In some embodiments, the method segments of the original image into superpixels, and then introduces offsets to those superpixels to create perturbations. In some embodiments, this can result in perturbed superpixels. Then, each superpixel can be masked (e.g., set all pixels to black) with probability p. The size of the superpixels can be large enough to accurately capture semantically meaningful features while being simultaneously fine-grained to exclude extraneous features irrelevant to the object of interest. To address this challenge, Auto-Zoom can employ a hierarchical iterative process.

The current set of experiments focused on generating explanations for the train object in the background, on the left-hand side of the image (smaller bounding box).

The value of M was varied between 25 and 300, and the value of p was varied between 0.1 and 0.9. For a pair of (M, p) values, the following steps were performed:
1. Image segmentation: The original image x is partitioned into n superpixels: sp₁, sp₂, ..., spₙ. The goal is to extract meaningful representations of the image. For this set of experiments, the watershed algorithm was used, and the number of markers was set to M.
2. Image perturbations: N perturbations are created from x. Each superpixel (sp₁, sp₂, ..., spₙ) is masked with a probability p. Masking a superpixel means setting all its pixels to a defined baseline color. For this set of experiments, black was used as the default baseline color.
3. Prediction outcomes: The image perturbations are fed into the object detection model m. The prediction outcome of a perturbation may comprise k objects with bounding box bbᵢ, class yᵢ, and prediction confidence pᵢ, where i=1, . . . k. All objects for which yᵢ ≠y are ignored. The relevance score of a perturbation is then computed as maxᵢ(IoU (bb, bbᵢ)×pᵢ) where IoU() stands for the intersection over union. Intuitively, a perturbation is more relevant when it includes an object of the same class as y, with high prediction confidence, and with a bounding box that overlaps with bb.
4. Surrogate model: Using the perturbations and their relevance scores, a linear model (e.g., a regression model) is fitted to learn the relationships between the superpixels and the relevance scores. The goal is to identify the most relevant superpixels through their learned coefficients. In these experiments, the ridge regression algorithm was used.
5. Gradual image reconstruction: The superpixels are sorted in descending order of relevance (e.g., based on the learned coefficients or weights of the linear model), and the top j superpixels are gradually inserted into a baseline image, e.g., a black image. For each added superpixel, the reconstructed image is fed into m and its relevance score is computed as in step 3. As soon as a reconstructed image results in a strictly positive relevance score, the identified top j most relevant superpixels are returned.

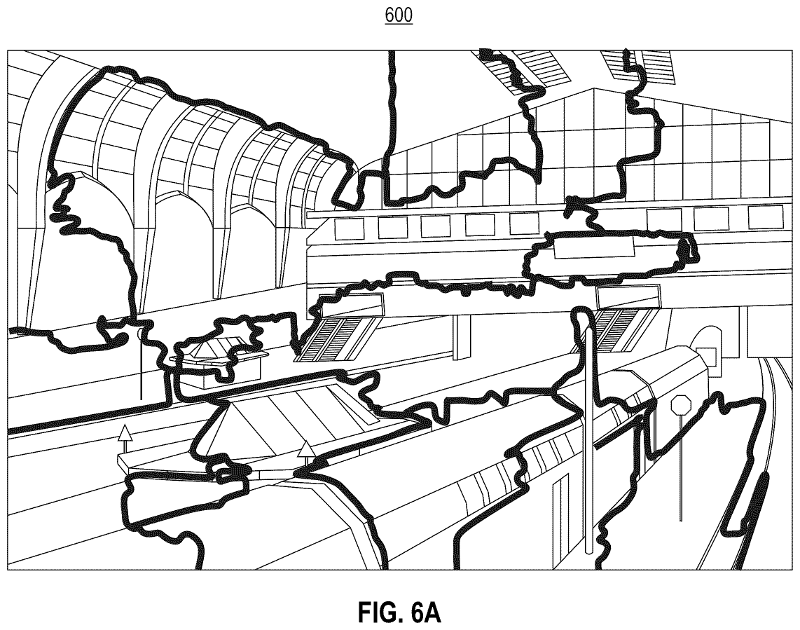

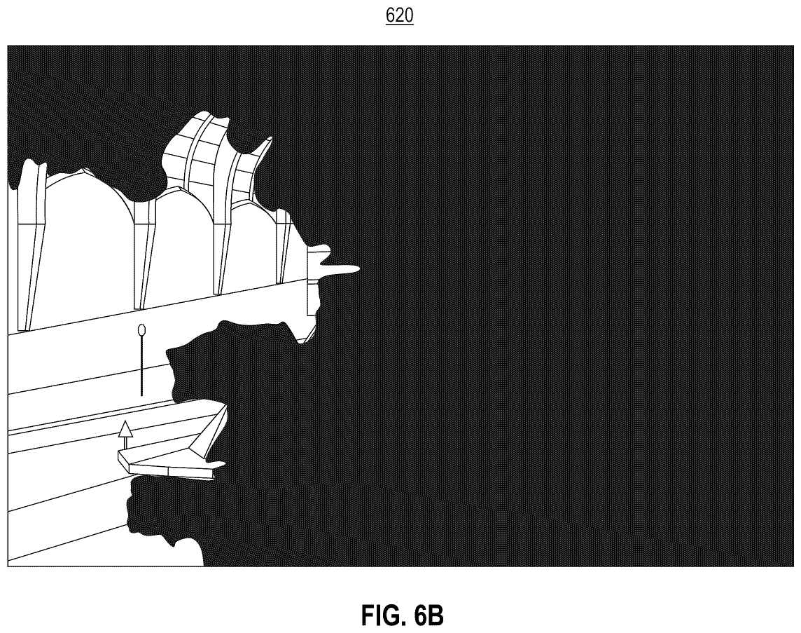

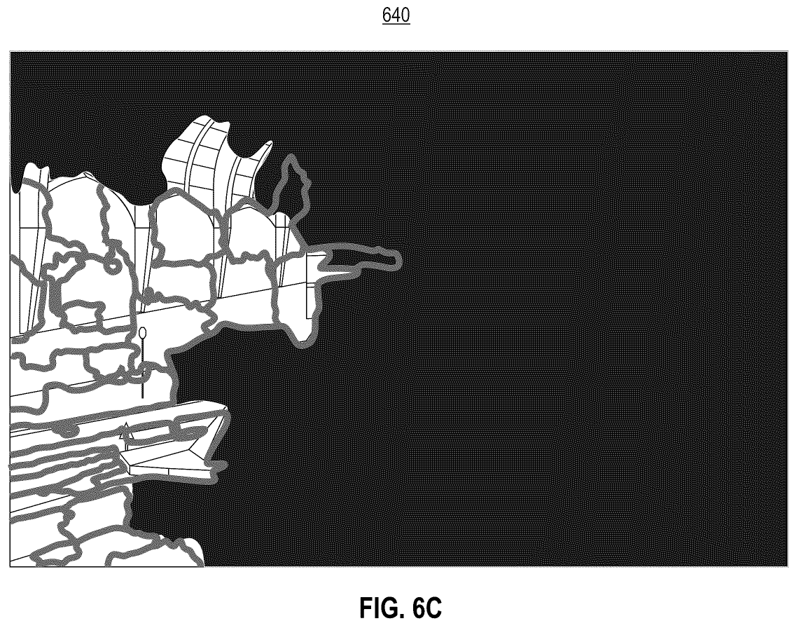

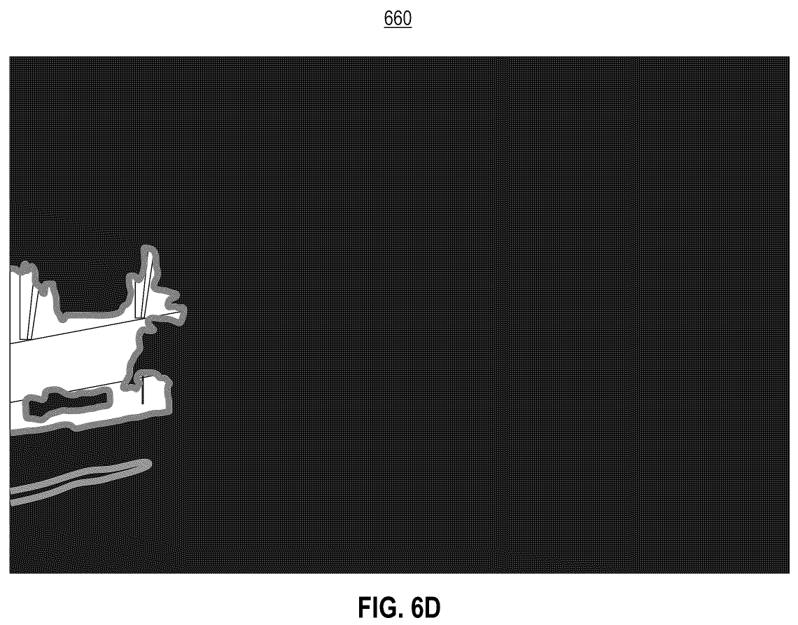

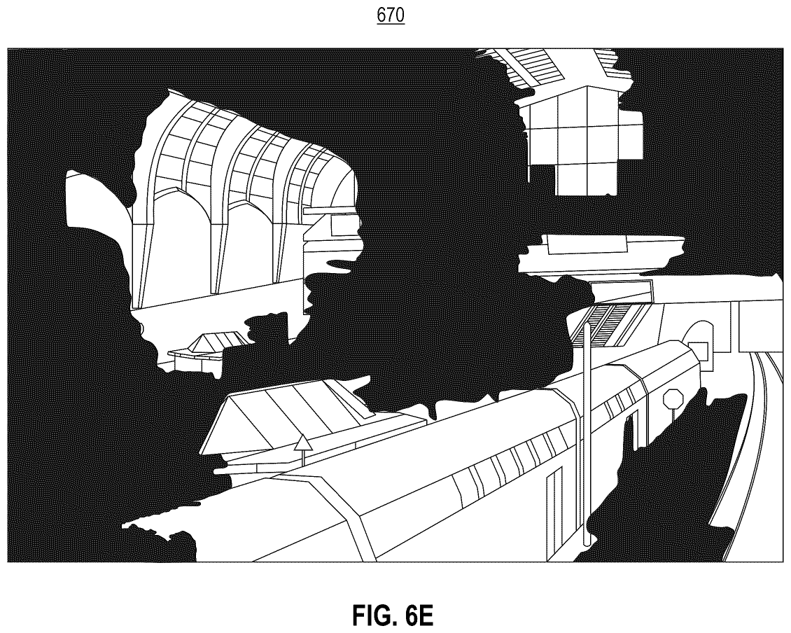

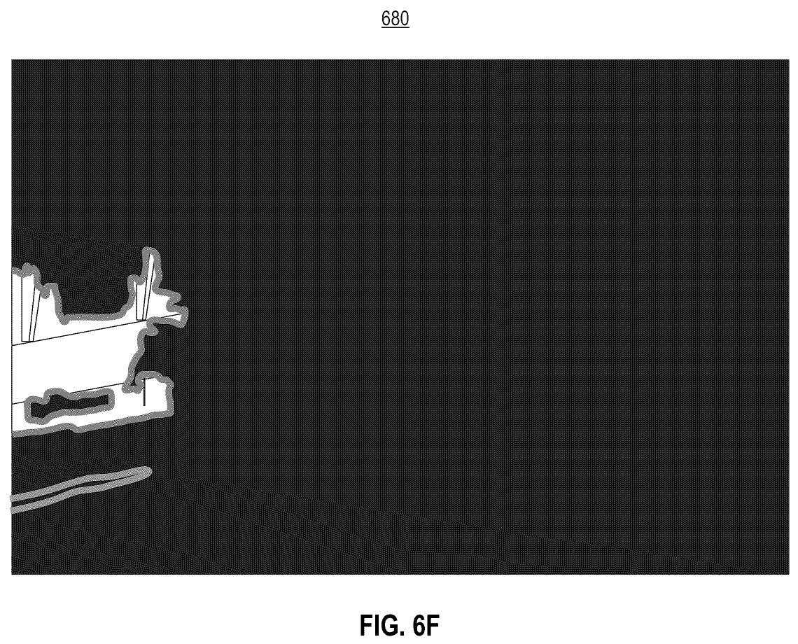

FIG. 6A is an image 600 illustrating an example of segmentation to generate superpixels according to embodiments of the present disclosure.

FIG. 6B is an image 620 illustrating an example of identification of relevant superpixels according to embodiments of the present disclosure.

FIG. 6C is an image 640 illustrating an example of segmentation of relevant superpixels into smaller superpixels according to embodiments of the present disclosure.

FIG. 6D is an image 660 illustrating an example of identification of relevant smaller superpixels according to embodiments of the present disclosure.

In Auto-Zoom's hierarchical iterative process, the image is segmented into large superpixels (FIG. 6A). The relevant superpixels for the object of interest are identified (FIG. 6B). The identified relevant superpixels are further segmented into smaller superpixels (FIG. 6C), and the relevant superpixels for the object of interest are again identified (FIG. 6D). The probability p of masking superpixels is decreased at every iteration.

FIG. 6E is an image 670 illustrating an example of image perturbation via superpixel masking according to embodiments of the present disclosure. In various embodiments, perturbations are created via the following steps. Each superpixel is masked with a probability p. If a superpixel is not masked, the superpixel is retained and therefore is active.

Although FIGS. 6A-6F illustrate the outcomes from each step of Auto-Zoom for two iterations, the process can be conducted for additional iterations. FIGS. 6B and 6D illustrate the identified relevant superpixels at the end of the first and the second iterations, respectively. The explanations become progressively fine grained and focused with each iteration. Interestingly, from FIG. 6D, the model relies in part on the surrounding context, e.g., a portion of a rail, external to the bounding box of the train of interest to identify the train. Both the train of interest and the surrounding context are effectively captured by Auto-Zoom.

Challenges in designing black-box explanation techniques for object detection are addressed by the design of Auto-Zoom in various embodiments.

One challenge in perturbation-based explanation techniques is in determining the size of the superpixels that can preserve the semantic meaning of the selected features. One one hand, the superpixels should be large enough to fully contain a feature and preserve its semantic meaning. On the other hand, the superpixels should not be so large as to include features that are not relevant to the object of interest.

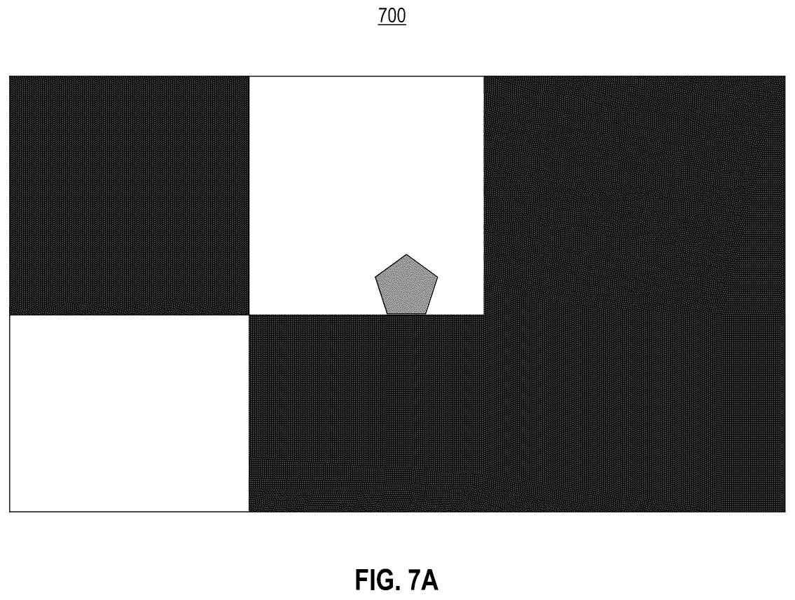

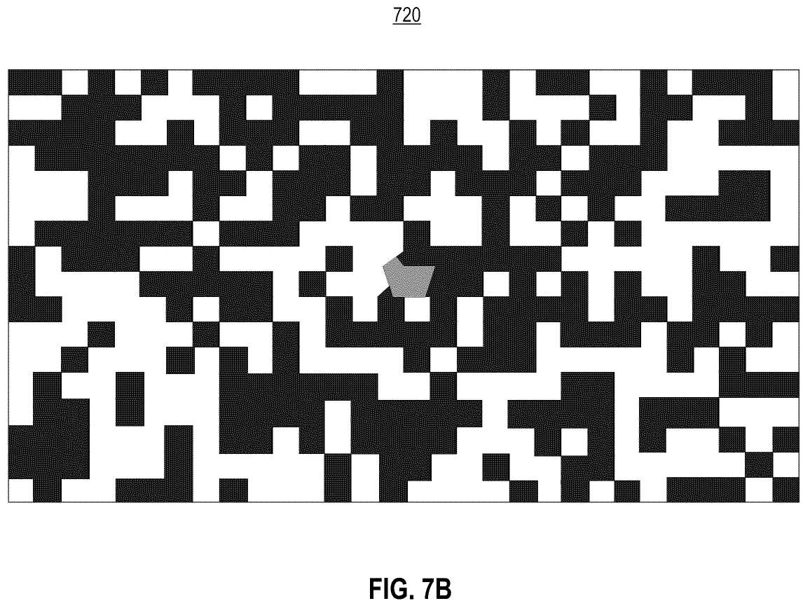

FIG. 7A is an image 700 illustrating a toy example of perturbation with large superpixels. Here, the object to be explained is illustrated as a pentagon. As shown in FIG. 7A the model can detect the target object in a number of perturbations. However, as shown in FIG. 7A, extraneous features irrelevant to the object can also get included in the large superpixels.

FIG. 7B is an image 720 illustrating a toy example of perturbation with small superpixels. Here, the object to be explained is illustrated as a pentagon. As shown in FIG. 7B, with smaller superpixels, the model can fail to identify the object of interest in most perturbations because in most perturbations, some masked superpixels may obstruct parts of the object that are necessary for the model's detection of the object, preventing the model from detecting the object. Here, the masked superpixels cover part of the object such that an object detection model can determine, incorrectly, that the object can be a hexagon or a different polygon. Then, without the ability to detect the object of interest in most perturbations, the surrogate model also can fail to identify the relevant superpixels.

To address the above challenge of superpixel size determination, in various embodiments, Auto-Zoom takes an iterative approach to identifying the right superpixel size.

In various embodiments, relevant superpixels are identified. In various embodiments, a progressive refinement of the explanation is performed by further segmentation of the larger superpixels into smaller ones. Again, this is to identify the minimum set of fine-grained salient features for the object to be explained. This approach, however, minimizes the chances of smaller superpixels failing to capture relevant features, as only the relevant larger superpixels are further split into smaller ones.

In various embodiments, due to its hierarchical iterative process, Auto-Zoom can generate fine-grained explanations with small superpixels of size sₖ. In various embodiments, the hierarchical property of Auto-Zoom, where the set of considered superpixels is reduced to only the identified relevant superpixels and the probability p of superpixel masking is decreased with each iteration, increases the chances that the model detects the object of interest, and thereby increases the chances that Auto-Zoom can generate a fine-grained explanation for the object of interest. Alternatively, if the superpixel size is set to sₖ and the entire image is segmented accordingly, masks are randomly generated throughout the image, increasing the chances that the model fails to detect the object of interest. Instead, as with the hierarchical property of Auto-Zoom in various embodiments, the probability of masking, p, should be lower close to the relevant features in order to preserve their semantic meaning.

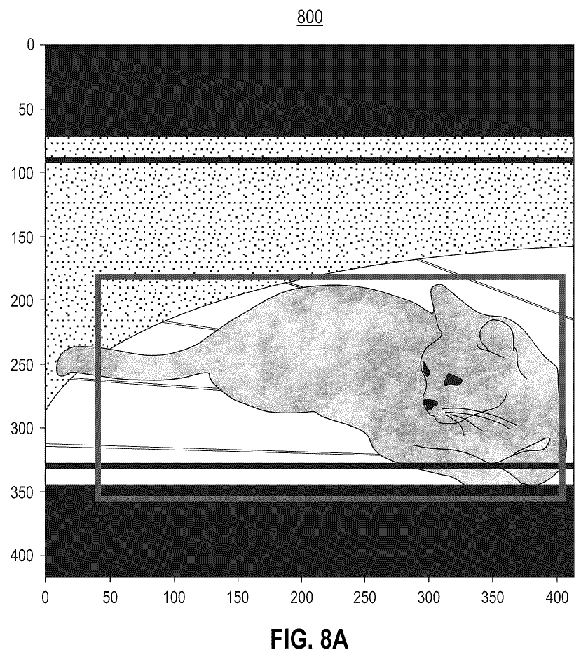

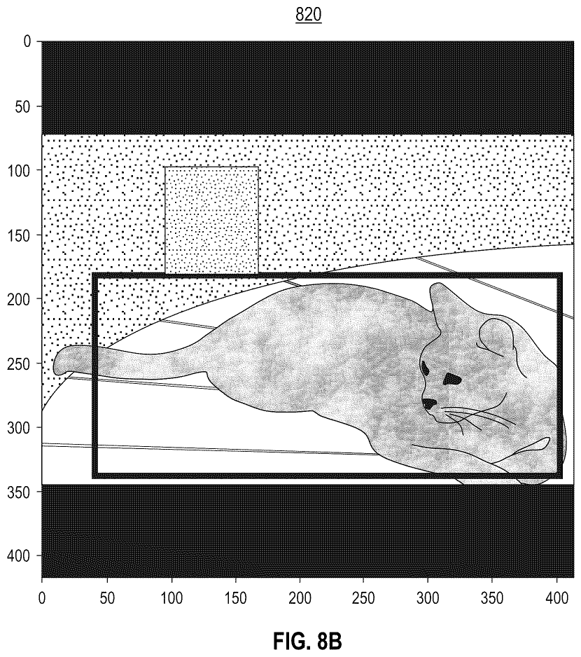

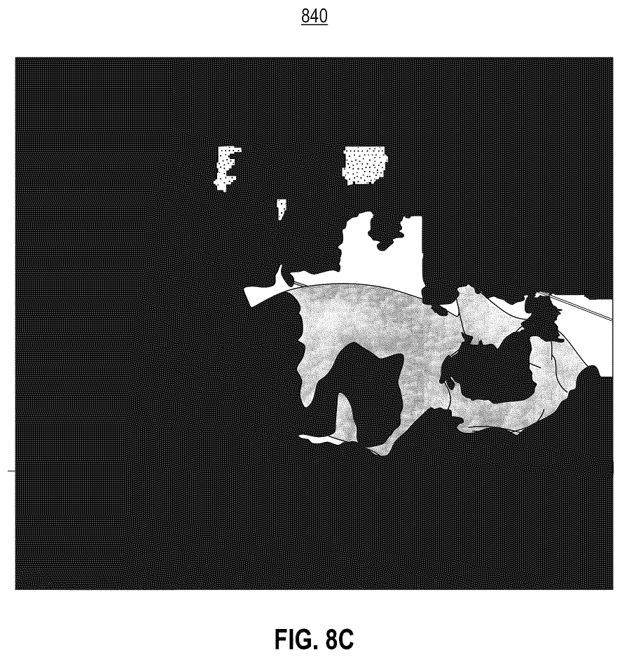

Another challenge is that black-box explanation techniques developed for image classification cannot be applied directly to the outcomes of object detection. Instead, explanation techniques specifically designed for object detection are needed. Alternate black-box explanation methods for image classification have been suggested to be applied to object detection according to the examples shown in FIGS. 8A-8C.

The above-illustrated approach directly applying methods for image classification to object detection outcomes makes the implicit assumption that features relevant for an object are all contained inside the bounding box of the object. While this assumption may be valid for the object, object detection models, in general, may rely on context information, external to the bounding box of an object, to identify the object. When setting all pixels outside of the highlighted object's bounding box to black or blank, the model either predicts a different class, or fails to detect any object at all.

In some embodiments, an alternative image cropping approach fails to generate an explanation for an object detection model's detection in the image. When cropping the object, the model no longer detects a train, but instead labels the object as a bus. This demonstrates that the model relies on features that are external to the object's bounding box.

To address the above challenge regarding model reliance on features external to the bounding box of the object of interest, in various embodiments, Auto-Zoom does not make any assumption about the location of the relevant features and allows the iterative approach to automatically detect all the relevant superpixels. Auto-Zoom is thus able to successfully capture context information used by an object detection model for detecting an object.

In various embodiments, Auto-Zoom is a hierarchical and iterative black-box explanation method to identify relevant features behind an object detection model's prediction outcome.

In various embodiments, given an object detection model m, an image x, and an object with bounding box bb and class y, a single Auto-Zoom iteration comprises the following steps:
1. Image segmentation: The original image x is partitioned into n superpixels: sp₁, sp₂, ... , spₙ. For example, a “watershed algorithm” can be employed to perform the partitioning. Other examples of image segmentation methods that can be used include clustering-based segmentation, threshold-based segmentation, adaptive thresholding, edge detection, panoptic segmentation, region-based segmentation, semantic segmentation, instance segmentation, region growing, deconvolution, feature extraction, and U-Net. The image segmentation extracts meaningful representations of the image.
2. Image perturbations: N perturbations are created from x. Each superpixel (sp₁, sp₂, ..., spₙ) is masked with a probability p (e.g., 0.5). Masking a superpixel means setting all its pixels to a defined baseline color, e.g., black.
3. Prediction outcomes: The image perturbations are fed into the object detection model m. The prediction outcome of a perturbed superpixel may comprise k objects with bounding box bbᵢ, class yᵢ, and prediction confidence pᵢ, where i=1, . . . k. All objects for which yᵢ≠y are ignored. The relevance score of the superpixel is then computed as maxᵢ(IoU (bb, bbᵢ)×pᵢ) where IoU() stands for the intersection over union. Intuitively, a perturbation is more relevant when it includes an object of the same class as y, with high prediction confidence, and with a bounding box that overlaps with bb.
4. Surrogate model: Using the perturbations and their relevance scores, a linear model (e.g., a regression model, such as a ridge regression algorithm) is fitted to learn the relationships between the superpixels and the relevance scores. The goal is to identify the most relevant superpixels through their learned coefficients.
5. Gradual image reconstruction: The superpixels are sorted in descending order of relevance (e.g., based on the learned coefficients or weights of the linear model), and the top j superpixels are gradually inserted into a baseline image, e.g., a black image. For each added superpixel, the reconstructed image is fed into m and its relevance score is computed as in step 3. A strictly positive relevance score indicates that the reconstructed image leads the model to identify an object of the desired class that also overlaps with the bounding box bb. When the relevance score exceeds a configured threshold (e.g., 0.5), the top j most relevant superpixels have been identified.

The above steps describe the operations for an iteration. The output of the last step provides an explanation for the object detection model m's identification of the object with bounding box bb and class y. To obtain more fine-grained explanations, the above steps can be repeated starting from step 2 after updating the image x to include only the identified relevant superpixels, segmenting the identified relevant superpixels into smaller superpixels, and decreasing the probability of superpixel masking p to address the over-masking problem previously. The above steps can be conducted for a specified number of iterations (e.g., 2), or until the last step, gradual image reconstruction, can no longer return a strictly positive relevance score or a score that exceeds a configured threshold, in which case, the results from the previous iteration can be returned.

Experiments have been conducted to evaluate the effectiveness of Auto-Zoom in various embodiments, and to assess the quality of Auto-Zoom's explanations in various embodiments. Specifically, two sets of experiments have been run. The first set compares explanations of Auto-Zoom in various embodiments with those of D-RISE, a recent black-box explanation method for object detection. The second set of experiments assesses the ability of Auto-Zoom in various embodiments to localize the relevant features for an object detection model's identification of an object, and relies on adversarial patches to set the ground-truth.

The experiments were run on a server with an NVIDIA Tesla V100 PCIe 32GB GPU card. For the object detection model, unless specified otherwise, Darknet Yolo Version 3 trained on the COCO dataset was used. The software is public domain. The model configuration (yolov3.weights) and weights (yolov3.weights) can be downloaded from https://pjreddie.com/darknet/yolo/. The detection threshold was set to 0.1. Auto-Zoom was run for two iterations. For image segmentation, the watershed algorithm was used, with a compactness parameter of 0.001. In the first iteration, the number of markers was set to 25 to obtain large superpixels. In the second iteration, a value between 250 and 300 markers was chosen to obtain smaller superpixels. For the second iteration, the final superpixels were derived from the overlap between the output of the watershed algorithm and the outcome from the previous iteration. N image perturbations were created, where N was set to ten times the number of superpixels. The probability of superpixel masking p was set to 0.5 in the first iteration, and 0.8 in the second iteration. The threshold for the gradual image reconstruction step was set to 0. Settings specific to the different experiments are further described in their respective sections.

The first set of experiments comprised a comparison of Auto-Zoom in various embodiments with D-RISE.

The objective of the first set of experiments was to compare Auto-Zoom in various embodiments with alternative black-box explanation methods for object detection, specifically D-RISE.

One difference between D-RISE and Auto-Zoom in various embodiments is the way D-RISE generates masks. In particular, D-RISE does not rely on image segmentation, nor superpixels, but instead samples N binary masks of size smaller than the image size by setting each element independently to 1 with a probability p, and to 0 with probability 1-p. D-RISE then upsamples all masks to the image size using bilinear interpolation.

For the first set of experiments, images and objects of interestwere used. For each image and object of interest, explanations were generated using D-RISE and Auto-Zoom in various embodiments.

D-RISE was implemented, and the number of perturbations, the ratio of the image size to the binary mask size, and the making probability were set to their suggested default values, i.e., 2000, 8, and 0.5. As a difference, the cosine similarity term in the similarity metric was ignored because D-RISE's object detectors return only the classes with a confidence above a threshold for a region, and not the probabilities for each of the possible classes.

In some embodiments, and in contrast to alternative methods such as D-RISE, for each of the images and objects of interest, Auto-Zoom successfully identifies the relevant superpixels. In addition, in various embodiments, Auto-Zoom includes a validation step wherein superpixels are gradually inserted into a blank image until the relevance score exceeds a specified threshold, confirming the relevance of the highlighted superpixels.

The failure of D-RISE to generate explanations may be related to the issue of masking obstructing the object to be explained, as described further above. Although D-RISE does not rely on superpixels, it still relies on masks and perturbations, and can therefore stall when the object to be explained relies on multiple features placed at different locations in the image. When the mask obstructs any of the relied-upon features, D-RISE's model fails to identify the object to be explained. For example, both objects to be explained are masked, preventing the perturbation from providing a positive relevance score (also called similarity score).

A second set of experiments involved the localization of an adversarial patch.

The objective of the second set of experiments was to evaluate the accuracy of Auto-Zoom in various embodiments in localizing the features relevant for an object detection model's identification of an object of interest.

A challenge in evaluating explanation methods comes from the lack of ground-truth. Therefore, in the second set of experiments, alternative adversarial work was used to define the ground-truth. Specifically, it has been demonstrated that a properly designed adversarial patch, placed at different locations in an image, can cause objects in the image to be suppressed or detected as belonging to different classes. As such, the image of interest, the object to be explained, and the ground-truth were identified as follows. Given an image x, let O denote the list of objects detected by the model m in x. An adversarial patch is generated and added to x, using an algorithm implemented as part of the Adversarial Robustness Toolbox (MIT License). The modified image is called x′, and O′ is the list of objects detected by m in x′. If ∃o∈ [symbol] ′\ [symbol] , then o is selected as the object to be explained. Intuitively, the newly detected object by m caused by the insertion of the adversarial patch, which represents part of the reason (e.g., ground-truth) for that newly detected object, was focused on. An explanation was generated via Auto-Zoom, and it was verified whether the identified superpixels included, or overlapped with, the adversarial patch. The use of the adversarial patch in these experiments was to establish ground-truth for explanations.

For generating the adversarial patch, the following parameters were set. The number of iterations was 30,000, with a learning rate of 5/255, a patch size of (h=80, w=80), at location (100, 100), and with a clip threshold of (0, 1). Because the generation of the adversarial patch required the computation of the gradient, a PyTorch implementation of Yolo was adopted.

FIGS. 8A-8C illustrate the results for one image.

FIG. 8A is an image 800 illustrating an example of an input image with three detected objects—bear, bench, and cat—according to embodiments of the present disclosure.

FIG. 8B is an image 820 illustrating an example of an image with an adversarial patch according to embodiments of the present disclosure. The adversarial patch was generated and added to the original image. The resulting image, as shown in FIG. 8B, includes three detected objects: bear, cat, and dog. In particular, the adversarial patch caused the bench to be suppressed, and led the model to detect a new object, a dog. Therefore, the dog object was focused on, and Auto-Zoom was queried for an explanation regarding the detection of the dog object.

FIG. 8C is an image 840 illustrating an example of a generated explanation for the detection of a dog object in an image according to embodiments of the present disclosure. In particular, FIG. 8C presents the results of querying Auto-Zoom for an explanation of the detection of the dog object from FIG. 8B. The relevant superpixels, as shown in FIG. 8C, include part of the adversarial patch. Although one may initially expect the entire adversarial patch to be relevant, it in fact comprises many parts responsible not only for the introduction of the dog object, but also for the suppression of the bench, and the reduction in the prediction confidence of the cat. As such, in reality, only a fraction of the adversarial patch may be relevant for the dog. The fact that the identified superpixels cover part of the adversarial patch shows that Auto-Zoom successfully recognized the relevant features for the dog object.

The results of the above-described experiments demonstrate that in various embodiments, Auto-Zoom can successfully generate explanations when alternative solutions fail, and can correctly localize relevant features.

As a black-box technique, Auto-Zoom can be more computationally expensive than white-box explanation approaches such as gradient-based techniques, or layer-wise propagation rules. Specifically, white-box approaches may require tens of samples—for example, Integrated Gradient uses a default of 50 interpolated images, and Smooth Grad also suggests 50 samples. In contrast, black-box explanation approaches typically require two orders of magnitude more computations. For example, by default, LIME and D-RISE generate 1000 and 2000 perturbations, respectively.

However, while the hierarchical iterative segmentation of Auto-Zoom in various embodiments is introduced to adaptively reduce the size of the superpixels, it can also reduce the computational requirements. This is because assuming the number of required perturbations is proportional to the number of superpixels, the iterative steps significantly reduce the number of superpixels. In various experiments, it was found that in various embodiments, Auto-Zoom typically requires hundreds of forward passes of the object detector, hence reducing the computational cost by one order of magnitude compared to traditional black-box explanation approaches.

Object detectors fall into two categories. The first category comprises two-stage detectors (e.g., Faster R-CNN), where the first stage proposes candidate object bounding boxes, and the second stage extracts features from each candidate box for subsequent classification. In contrast, one-stage detectors (e.g., YOLO, SSD) proceed without the region proposal step. Auto-Zoom and embodiments of the present disclosure are applicable to both one-and two-stage detectors.

Alternative methods to explain object detectors require access to the inner layers of the model to compute the gradient, to implement layer-wise relevance propagation rules, or to extract feature map activations from specific layers. In contrast, the present disclosure focuses on black-box techniques since access to a model's inner layers may not be available.

D-RISE, a black-box explanation technique, produces saliency maps by computing perturbations and computing, for each perturbation, a similarity metric that takes into account the localization and classification aspects of the detection. However, D-RISE fails to generate saliency maps for small objects that depend on the surrounding context. In contrast, by adopting an adaptive hierarchical segmentation, Auto-Zoom successfully generates explanations for those images.

Challenges that are unique to explaining object detection outcomes have been demonstrated. Specifically, small objects that depend on the surrounding context, external to their bounding box, can cause alternative solutions to fail. The root causes (e.g., superpixel size) of the difficulty with small objects that depend on surrounding context have been explained. Auto-Zoom, a novel black-box explanation technique for object detectors, has been presented. In various embodiments, Auto-Zoom adopts a hierarchical iterative segmentation approach. This approach not only adaptively defines the size of the superpixel, but also decreases the computational cost by one order of magnitude compared to other black-box solutions. Comprehensive experiments were conducted, demonstrating that Auto-Zoom, in various embodiments, successfully generates explanations for complex objects and images where alternative solutions fail. In addition, the ability of Auto-Zoom, in various embodiments, to precisely localize relevant features by using adversarial patches as ground-truth has been demonstrated. The use of adversarial patches in experiments was to establish ground-truth for explanations.

Deep learning based systems often operate as black-boxes, raising concerns as to whether a model learns the right concepts, or learns implicit bias that could cause harm to society. By introducing a novel method to explain object detectors, the present disclosure strives to reduce the potential risks associated with black-box deep models, increase interpretability and transparency, and ultimately improve the understanding of and trust in deep learning based systems.

Further experiments were performed to compare Auto-Zoom in various embodiments with non-hierarchical methods of generating explanations for an object detection model's detection of an object. In particular, these experiments explored the question of whether one can simply run a black-box explanation technique with varying parameters (e.g., increasingly smaller superpixel sizes) to obtain a fine-grained explanation. Although, in various embodiments, Auto-Zoom proposes a hierarchical iterative process, one may question what benefit the hierarchical property provides. This set of experiments was intended to address this question.

Black-box explanation techniques rely on perturbations, which in turn depend on two main parameters: M, the number of superpixels (which is inversely proportional to the superpixel size); and p, the probability of masking superpixels. Given an object detection model m, an image x, and an object with bounding box bb and class y, explanations were generated with varying (M, p) values.

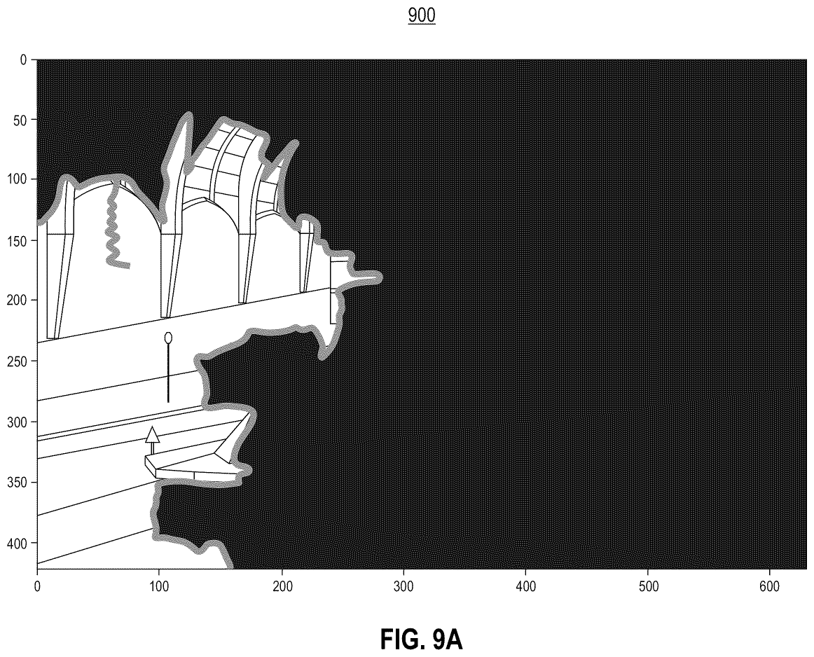

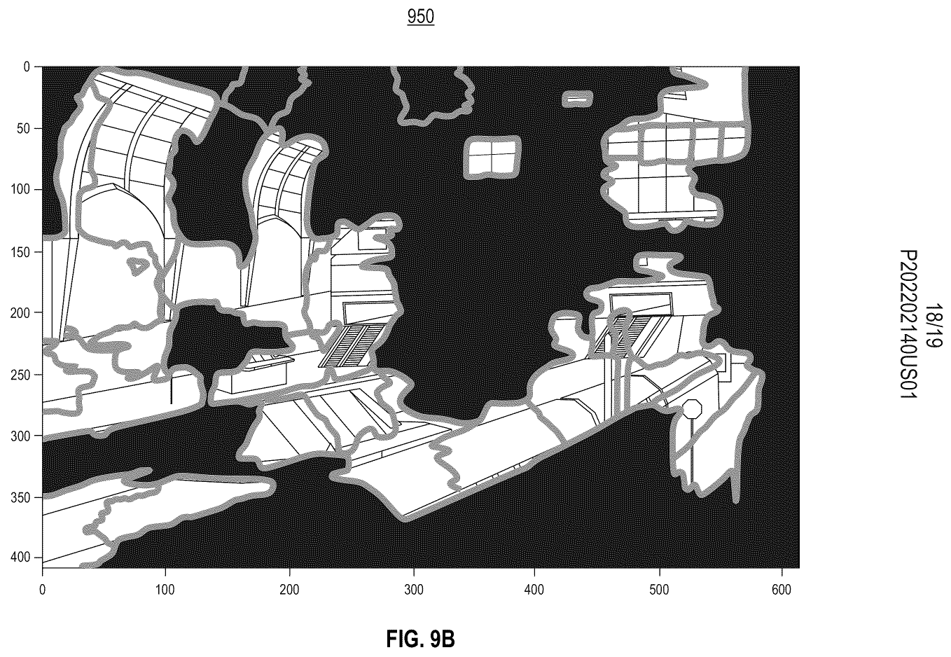

FIGS. 9A-9B illustrate obtained explanations for the above experiments.

FIG. 9A is an image 900 illustrating an example of a generated explanation for an object detection model's detection of a train in an image, where M, the number of superpixels, is set to 25, and p, the probability of masking superpixels, is set to 0.1, according to embodiments of the present disclosure.

FIG. 9B is an image 950 illustrating an example of a generated explanation for an object detection model's detection of a train in an image, where M, the number of superpixels, is set to 100, and p, the probability of masking superpixels, is set to 0.1, according to embodiments of the present disclosure.

In some embodiments, other experiments (not shown) used the following parameters:
a. M, the number of superpixels, is set to 200, and p, the probability of masking superpixels, is set to 0.1, according to embodiments of the present disclosure.
b. M, the number of superpixels, is set to 300, and p, the probability of masking superpixels, is set to 0.1, according to embodiments of the present disclosure.
c. M, the number of superpixels, is set to 25, and p, the probability of masking superpixels, is set to 0.5, according to embodiments of the present disclosure.
d. M, the number of superpixels, is set to 100, and p, the probability of masking superpixels, is set to 0.5, according to embodiments of the present disclosure.
e. M, the number of superpixels, is set to 200, and p, the probability of masking superpixels, is set to 0.5, according to embodiments of the present disclosure.
f. M, the number of superpixels, is set to 300, and p, the probability of masking superpixels, is set to 0.5, according to embodiments of the present disclosure.
g. M, the number of superpixels, is set to 25, and p, the probability of masking superpixels, is set to 0.9, according to embodiments of the present disclosure.
h. M, the number of superpixels, is set to 100, and p, the probability of masking superpixels, is set to 0.9, according to embodiments of the present disclosure.
i. M, the number of superpixels, is set to 200, and p, the probability of masking superpixels, is set to 0.9, according to embodiments of the present disclosure.
j. M, the number of superpixels, is set to 300, and p, the probability of masking superpixels, is set to 0.9, according to embodiments of the present disclosure.

Observation 1: The default value for the masking probability p in black-box explanation techniques (e.g., LIME, D-RISE) is 0.5. As expected, as the number of superpixels is small (and size is inversely large), the explanation includes the area with the object to be explained, but the superpixels may contain extraneous features. As the number of superpixels is increased (and inversely, the superpixel sizes are decreased), the identified superpixels surprisingly no longer contain the object to be identified. As the size of the superpixels decreases, the model fails to detect the object to be explained in most perturbations. The weights of the surrogate linear model are therefore not reflective of the importance of the superpixels for the object to be identified. Instead, as superpixels are gradually added to the reconstructed images, the model detects the other train object in the foreground, and because the bounding box of the train object in the foreground overlaps with that of the object to be explained, the relevance score becomes strictly positive. In other words, a strictly positive relevance score is obtained not because the superpixels are relevant, but because the image contains another object of the same class as the one to be explained, and with overlapping bounding boxes. This probably also explains the reasons the explanation generated by D-RISE highlights the train object in the foreground.

Observation 2: As the masking probability p is varied (e.g., from 0.1 to 0.9), the explanations tend to be poor. Specifically, high masking probabilities (e.g., p=0.9) result in few superpixels being active or retained. The model fails to detect the object to be explained in most perturbations, and the weights of the surrogate linear model are not reflective of the actual relevance of the superpixels for the object to be explained. As a result, the object to be explained may not even be included in the identified superpixels. Inversely, low masking probability (e.g., p=0.1) results in the object to be explained to be present in most perturbations, and consequently, the explanations cannot focus on the most relevant features. Instead, the explanations include a significant amount of extraneous features.

Observation 3: In some embodiments, explanations use the same superpixel size as the final explanation produced by Auto-Zoom after two iterations, as in FIG. 6F.

The experiments demonstrate the benefits of the hierarchical iterative segmentation. Without this property, superpixels are randomly masked uniformly. Instead, it is beneficial for superpixels to be masked with a lower probability around the features of relevance to preserve their semantic meaning.

Further experiments were performed to compare Auto-Zoom in various embodiments to D-RISE. These experiments further explored the question of how explanations from Auto-Zoom in various embodiments compare with those from alternative solutions such as D-RISE. The same methodology and settings were adopted. The main difference is that the current experiments were run on a larger number of images and objects selected from the COCO dataset.

The results fall into two main categories:
1. For large objects whose sole presence suffices for the model to detect them, both D-RISE and Auto-Zoom identify similar areas in the images.
2. For smaller objects whose sole presence does not suffice for the model to detect them, but for which the model relies on additional surrounding objects, D-RISE often fails to highlight any pixel, or may highlight large areas which may comprise extraneous and questionable figures. In contrast, Auto-Zoom successfully generates explanations for the same images by highlighting small areas which include the relevant surrounding objects (e.g., person, car, sink.

While D-RISE may fail to generate explanations, Auto-Zoom still successfully generates fine-grained meaningful explanations.

Further experiments were performed to hyperparameter-tune D-RISE. These experiments explored the question of whether adjusting the parameters of D-RISE can result in a fine-grained meaningful explanation. D-RISE takes 3 inputs: (1) N: number of masks (default value of 2000), (2) s: ratio of image to mask (default value of 8), (3) p: probability of setting an element in the mask to 1 (default value of 0.5).

Most of the explanations generated via D-RISE failed to highlight any pixel. Few explanations distinguished relevant pixels, but the areas of relevance were large and scattered throughout the image. However, a closer look reveals that the area of relevance highlights a number of standing persons, and the explanation does not even highlight the object to explain, rendering its validity questionable.

For small objects for which the object detection model depends on other surrounding objects to detect, varying the parameters of D-RISE still fails to result in fine-grained meaningful explanations. The reasons are similar to those described above—although D-RISE does not use on superpixels, it still relies on masks. Intuitively, the parameter s controls the size of the regions to activate or mask. However, even with D-RISE, regions are randomly masked uniformly. Instead, regions around relevant objects should be masked with a lower probability to preserve their semantic meaning.

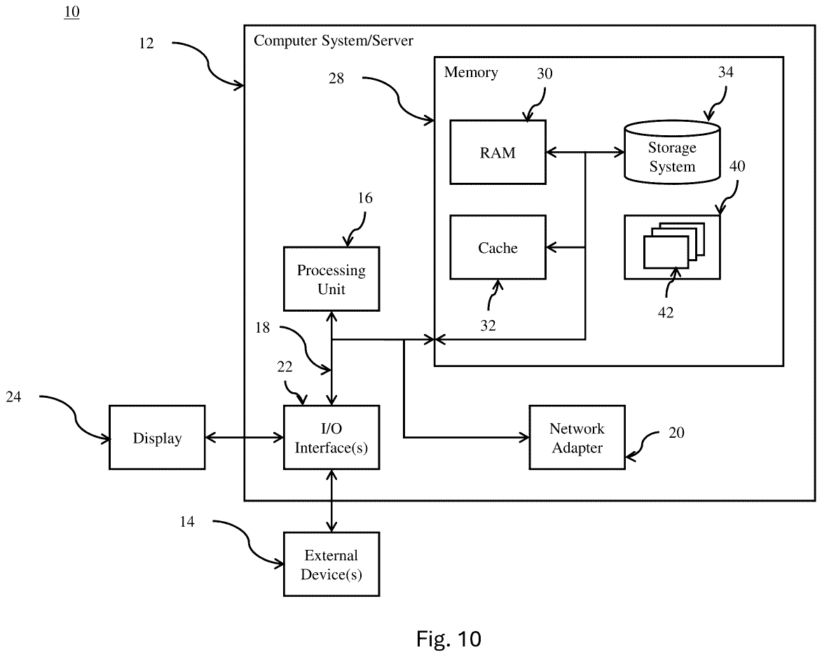

FIG. 10 is a block diagram illustrating an example of a computing node. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
reading an input image and an object identified by an object detection model, the identified object defined by a bounding box and a class;
segmenting the input image into a plurality of superpixels;
generating a plurality of perturbations of the input image to create a perturbed image, each of the plurality of perturbations being associated with one of the plurality of superpixels;
identifying, for each of a set of superpixels of the plurality of superpixels of the perturbed image, at least one predicted object in that superpixel, the at least one predicted object defined by a bounding box and a class, the identifying being performed using the object detection model;
calculating a first relevance score for each superpixel of the set based on an intersection over union of the bounding box of the at least one predicted object of that superpixel and the bounding box of the identified object of the input image;
generating, by a linear model, for each superpixel of the set, a weight based on that superpixel and the relevance score of that superpixel;
adding, to an output image, a superpixel being associated with a highest weight of the plurality of weights generated by the linear model;
calculating a second relevance score for the output image based on an intersection over union of the bounding box of a predicted object in the output image and the bounding box of the identified object of the input image; and
determining whether the second relevance score exceeds a relevance score threshold.

2. The method of claim 1, further comprising:
responsive to determining that the output image's relevance score does not exceed the relevance score threshold, adding, to the output image, a second superpixel being associated with a second highest weight of the linear model.

3. The method of claim 1, further comprising:
determining that the output image's relevance score exceeds the relevance score threshold; and
outputting the output image.

4. The method of claim 1, further comprising:
determining that the output image's relevance score does not exceed the relevance score threshold; and
outputting the output image from a previous iteration.

5. The method of claim 1, wherein generating a plurality of perturbations introducing an offset to each superpixel.

6. The method of claim 5, further comprising:
segmenting the output image into smaller superpixels;
decreasing a probability p; and
iterating the method by providing the segmented output image as the input image for a next iteration.

7. The method of claim 1, wherein calculating a relevance score for the first superpixel is further based on a prediction confidence.

8. A system comprising:
a computing node comprising a computer readable storage medium having program instructions embodied therewith, the program instructions executable by a processor of the computing node to cause the processor to perform a method comprising:
reading an input image and an object identified by an object detection model, the identified object defined by a bounding box and a class;
segmenting the input image into a plurality of superpixels;
generating a plurality of perturbations of the input image to create a perturbed image, each of the plurality of perturbations being associated with one of the plurality of superpixels;
identifying, for each of a set of superpixels of the plurality of superpixels of the perturbed image, at least one predicted object in that superpixel, the at least one predicted object defined by a bounding box and a class, the identifying being performed using the object detection model;
calculating a first relevance score for each superpixel of the set based on an intersection over union of the bounding box of the at least one predicted object of that superpixel and the bounding box of the identified object of the input image;
generating, by a linear model, for each superpixel of the set, a weight based on that superpixel and the relevance score of that superpixel;
adding, to an output image, a superpixel being associated with a highest weight of the plurality of weights generated by the linear model;
calculating a second relevance score for the output image based on an intersection over union of the bounding box of a predicted object in the output image and the bounding box of the identified object of the input image; and
determining whether the second relevance score exceeds a relevance score threshold.

9. The system of claim 8, wherein the processor-executable program instructions, when executed by the processor, further cause the processor to:
responsive to determining that the output image's relevance score does not exceed the relevance score threshold, add, to the output image, a second superpixel being associated with a second highest weight of the linear model.

10. The system of claim 8, wherein the processor-executable program instructions, when executed by the processor, further cause the processor to:
determine that the output image's relevance score exceeds the relevance score threshold; and
output the output image.

11. The system of claim 8, wherein the processor-executable program instructions, when executed by the processor, further cause the processor to:
determine that the output image's relevance score does not exceed the relevance score threshold; and
output the output image from a previous iteration.

12. The system of claim 8, wherein generating a plurality of perturbations comprises introducing an offset to each superpixel.

13. The system of claim 8, wherein the method further comprises:
segmenting the output image into smaller superpixels;
decreasing a probability p; and
iterating the method performed by the processor by providing the segmented output image as the input image for a next iteration.

14. The system of claim 8, wherein calculating a relevance score for the first superpixel is further based on a prediction confidence.

15. A computer program product for generating an explanation for a prediction of an object detection model, the computer program product comprising a computer readable storage medium having program instructions embodied therewith, the program instructions executable by a processor to cause the processor to perform a method comprising:
reading an input image and an object identified by an object detection model, the identified object defined by a bounding box and a class;
segmenting the input image into a plurality of superpixels;
generating a plurality of perturbations of the input image to create a perturbed image, each of the plurality of perturbations being associated with one of the plurality of superpixels;
identifying, for each of a set of superpixels of the plurality of superpixels of the perturbed image, at least one predicted object in that superpixel, the at least one predicted object defined by a bounding box and a class, the identifying being performed using the object detection model;
calculating a first relevance score for each superpixel of the set based on an intersection over union of the bounding box of the at least one predicted object of that superpixel and the bounding box of the identified object of the input image;
generating, by a linear model, for each superpixel of the set, a weight based on that superpixel and the relevance score of that superpixel;
adding, to an output image, a superpixel being associated with a highest weight of the plurality of weights generated by the linear model;
calculating a second relevance score for the output image based on an intersection over union of the bounding box of a predicted object in the output image and the bounding box of the identified object of the input image; and
determining whether the second relevance score exceeds a relevance score threshold.

16. The computer program product of claim 15, wherein the processor-executable program instructions, when executed by the processor, further cause the processor to:
responsive to determining that the output image's relevance score does not exceed the relevance score threshold, add, to the output image, a second superpixel being associated with a second highest weight of the linear model.

17. The computer program product of claim 15, wherein the processor-executable program instructions, when executed by the processor, further cause the processor to:
determine that the output image's relevance score exceeds the relevance score threshold; and
output the output image.

18. The computer program product of claim 15, wherein the processor-executable program instructions, when executed by the processor, further cause the processor to:
determine that the output image's relevance score does not exceed the relevance score threshold; and
output the output image from a previous iteration.

19. The computer program product of claim 15, wherein generating a plurality of perturbations comprises introducing an offset to each superpixel.

20. The computer program product of claim 15, wherein calculating a relevance score for the first superpixel is further based on a prediction confidence.
